(19) United States
(12) Patent Application Publication
(10) Pub. No.: US 2025/0067710 A1
(43) Pub. Date: Feb. 27, 2025

(54) METHOD FOR CONSTRUCTING FINGERPRINT OF XIN SU NING CAPSULE AND FINGERPRINT

(71) Applicant: SHAANXI UNIVERSITY OF SCIENCE AND TECHNOLOGY, Xi'an (CN)

(72) Inventors: Chengyuan LIANG, Xi'an (CN); Changhua Ke, Xi'an (CN); Yue Xing, Xi'an (CN); Jingjing Zhou, Xi'an (CN); Jinrong Hu, Xi'an (CN); Boxin Zhang, Xi'an (CN); Yunfei Zhang, Xi'an (CN); Bingxing Zhang, Xi'an (CN); Wen Wang, Xi'an (CN); Fei Li, Xi'an (CN); Yifan Li, Xi'an (CN)

(21) Appl. No.: 18/628,190

(22) Filed: Apr. 5, 2024

(30) Foreign Application Priority Data
Aug. 23, 2023 (CN) 202311068950.3

(51) Int. Cl. G01N 30/86; G01N 30/02; G01N 30/16; G01N 30/72

(52) U.S. Cl. CPC G01N 30/8686; G01N 30/16; G01N 30/7233; G01N 2030/027

(57) ABSTRACT

The present invention provides a method for constructing a fingerprint of a Xin Su Ning capsule and a fingerprint. The method includes: S1: taking contents of Xin Su Ning capsules of different batches, adding a methanol aqueous solution, and performing ultrasonic extraction to obtain test article solutions; S2: injecting the test article solutions into a high performance liquid chromatograph, performing gradient elution, performing chromatographic analysis, and recording chromatograms from 0 to 140 min; S3: importing the chromatograms into a traditional Chinese medicine chromatographic fingerprint similarity evaluation system to obtain a fingerprint; and S4: performing mass spectral analysis on the test article solutions, and determining chemical constituents of chromatographic peaks in the fingerprint according to results of the mass spectral analysis. The method for constructing a fingerprint of a Xin Su Ning capsule provided in the present invention has advantages of simple, stable and high precision and good reproducibility.

### TECHNICAL FIELD

The present invention belongs to the field of traditional Chinese medicine detection, and in particular, to a method for constructing a fingerprint of a Xin Su Ning capsule and a fingerprint.

### BACKGROUND

“Xin Su Ning capsule” is a compound preparation obtained by processing 11 medicinal materials including rhizoma coptidis, rhizoma pinelliae, poria, fructus aurantii immaturus, radix dichroae, plumula nelumbinis, radix sophorae flavescentis, herba artemisiae annuae, radix et rhizoma ginseng, radix ophiopogonis, and radix et rhizoma glycyrrhizae. The capsule has the effect of clearing heat and transforming phlegm, calming and settling the mind, and the like, has marked effect in treating diseases such as palpitations, chest distress, vexation, susceptibility to fright, a dry mouth and a bitter taste, insomnia and excessive dreaming, vertigo, and knotted and regularly intermittent pulses caused by phlegm heat disturbing heart patterns, and is intended for coronary heart diseases and mild and moderate ventricular premature beats caused by viral myocarditis.

The quality of traditional Chinese medicines is directly related to the development of traditional Chinese medicines. In recent years, traditional Chinese medicines have been attracting increasing attention all over the world for the reliable therapeutic effectiveness, slight side effects, low toxicity, and rare drug tolerance of the traditional Chinese medicines. However, traditional Chinese medicines have complex chemical constituents, and the constituents affect each other, resulting in increased difficulty in controlling the quality of traditional Chinese medicines. At present, the quality control of Xin Su Ning capsules is simple, and a detection method is complex. In addition, current national standards for Xin Su Ning capsules only set out a requirement on the contents of berberine hydrochloride, but cannot reflect overall composition information of Xin Su Ning capsules and also cannot provide the basis of control and evaluation for the quality of capsules.

The prescription of the Xin Su Ning capsules focuses on clearing heat and transforming phlegm and calming and settling the mind, and meets the theory of integrating jun (or sovereign), chen (or minister), zuo (or assistant), and shi (or messenger) ingredient drugs in traditional Chinese medicine. In the prescription, the jun drugs are rhizoma coptidis and rhizoma pinelliae for clearing heat and transforming phlegm. Herba artemisiae annuae, radix dichroae, radix sophorae flavescentis, and plumula nelumbinis are the chen drugs that assist the jun drugs in clearing heat, transforming phlegm, removing toxins, clearing heart fire, and calming the mind. Poria and fructus aurantii immaturus are zuo drugs for regulating qi, draining dampness, and eliminating phlegm. Radix et rhizoma ginseng and radix ophiopogonis nourish the heart and restore the pulses, and are also zuo drugs. Radix et rhizoma glycyrrhizae is a shi for regulating and harmonizing all the drugs. In addition, rhizoma coptidis, rhizoma pinelliae, and radix dichroae open pungent and descend bitter, and collaborate with fructus aurantii immaturus to smoothen the qi movement, thereby making pulses and qi harmonious and continuous.

### SUMMARY

In view of the deficiencies in existing detection method and techniques, an objective of the present invention is to provide a method for constructing a fingerprint of a Xin Su Ning capsule and a fingerprint.

The present invention is implemented by using the following technical solution:

A method for constructing a fingerprint of a Xin Su Ning capsule includes the following steps:
S1. taking contents of Xin Su Ning capsules of different batches, adding a methanol aqueous solution, and performing ultrasonic extraction to obtain test article solutions;
S2. injecting the test article solutions into a high performance liquid chromatograph, performing gradient elution, performing chromatographic analysis, and recording chromatograms from 0 to 140 min;
S3. importing the chromatograms obtained in S2 into a traditional Chinese medicine chromatographic fingerprint similarity evaluation system, selecting chromatographic peaks that exist in all the chromatograms of the Xin Su Ning capsules of different batches as common peaks, and performing data importing, multipoint correction, and data matching on the chromatograms of the test article solutions, to obtain a fingerprint; and
S4. performing mass spectral analysis on the test article solutions, and determining chemical constituents of chromatographic peaks in the fingerprint according to results of the mass spectral analysis.

Preferably, in S1, a volume concentration of methanol in the methanol aqueous solution is 80%.

Preferably, in S1, a time of the ultrasonic extraction ranges from 20 min to 40 min.

Preferably, in S2, a detection wavelength used in the chromatographic analysis is 210 nm.

Preferably, in S2, a chromatographic column used in the high performance liquid chromatograph is a Hedera ODS-2-C18 (250 mm×4.6 mm, 10 μm) chromatographic column.

Preferably, in S2, a mobile phase used in the gradient elution is acetonitrile and a 0.1% formic acid aqueous solution.

Preferably, in S2, a procedure of the gradient elution is shown in the following table:

| Time (min) | Volume (%) of acetonitrile |
|---|---|
| 0-35 | 20-27 |
| 25-45 | 27-35 |
| 45-85 | 35-45 |
| 85-95 | 45-65 |
| 95-140 | 65-100 |

Preferably, in S2, a flow rate used in the gradient elution is 0.8 mL/min.

Preferably, in S4, it is determined that the chemical constituents of the chromatographic peaks in the fingerprint are respectively: a peak 1 is trifolirhizin, a peak 2 is naringenin, a peak 3 is kaempferol, a peak 4 is valine, a peak 5 is palmatine, a peak 6 is epiberberine, a peak 7 is liquiritigenin/isoliquiritigenin, a peak 8 is limonin, a peak 9 is liquiritin, a peak 10 is tetrandrine, a peak 11 is methylophiopogonanone A, a peak 12 is lotusine, a peak 13 is sophoridine/matrine, a peak 14 is sophoranol/oxymatrine, a peak 15 is kurarinone, a peak 16 is dehydropachymic acid, a peak 17 is polyporenic acid C, a peak 18 is quercetin, and a peak 19 is sophocarpine.
10. A fingerprint of a Xin Su Ning capsule constructed by using the foregoing method. Compared with the prior art, the present invention has the following beneficial effects:

In the present invention, according to the structural properties and characteristics of active constituents contained in a Xin Su Ning capsule, a method for detecting a fingerprint of the Xin Su Ning capsule is constructed. Repeated experiments verify and show that in the method for detecting a fingerprint of a Xin Su Ning capsule provided in the present invention, chromatographic peaks are adequately separate, a baseline is smooth, and a peak type is good, so that the types and quantities of chemical constituents contained in the capsule can be comprehensively reflected. In an HPLC fingerprint of the Xin Su Ning capsule established in the present invention, 19 common peaks and a standard fingerprint are obtained and recognized, and obtained chromatograms have high similarity. Stability, repeatability, and precision are calculated through a relative retention time and a relative peak area of a peak. RSD values of the relative retention time and the relative peak area are both less than 5.0%, showing that the method provided in the present invention has good reproducibility, and a fingerprint established using the method provided in the present invention has reliability. The method for detecting a fingerprint of a Xin Su Ning capsule provided in the present invention has advantages that the method is simple and stable and has high precision and good reproducibility, and can evaluate the quality of Xin Su Ning capsules more comprehensively and scientifically, thereby ensuring the quality and therapeutic effectiveness of products.

### BRIEF DESCRIPTION OF THE DRAWINGS

FIG. 1 is a chromatogram obtained in Embodiment 1 in a detection wavelength optimization process according to the present invention;

FIG. 2 is a chromatogram obtained in Embodiment 2 in a flow rate optimization process according to the present invention;

FIG. 3 is a chromatogram obtained in Embodiment 3 in an elution gradient optimization process according to the present invention;

FIG. 4 is a chromatogram obtained in Embodiment 4 in an elution gradient optimization process according to the present invention;

FIG. 5 is a chromatogram obtained in Embodiment 5 in an elution gradient optimization process according to the present invention;

FIG. 6 is a chromatogram obtained in Embodiment 6 in an elution gradient optimization process according to the present invention;

FIG. 7 is a chromatogram obtained in Embodiment 7 of an optimal method according to the present invention;

FIG. 8 is a mass spectrogram of trifolirhizin according to the present invention;

FIG. 9 is a mass spectrogram of naringenin according to the present invention;

FIG. 10 is a mass spectrogram of kaempferol according to the present invention;

FIG. 11 is a mass spectrogram of valine according to the present invention;

FIG. 12 is a mass spectrogram of palmatine according to the present invention;

FIG. 13 is a mass spectrogram of epiberberine according to the present invention;

FIG. 14 is a mass spectrogram of liquiritigenin/isoliquiritigenin according to the present invention;

FIG. 15 is a mass spectrogram of limonin according to the present invention;

FIG. 16 is a mass spectrogram of liquiritin according to the present invention;

FIG. 17 is a mass spectrogram of tetrandrine according to the present invention;

FIG. 18 is a mass spectrogram of methylophiopogonanone A according to the present invention;

FIG. 19 is a mass spectrogram of lotusine according to the present invention;

FIG. 20 is a mass spectrogram of sophoridine/matrine according to the present invention;

FIG. 21 is a mass spectrogram of sophoranol/oxymatrine according to the present invention;

FIG. 22 is a mass spectrogram of kurarinone according to the present invention;

FIG. 23 is a mass spectrogram of dehydropachymic acid according to the present invention;

FIG. 24 is a mass spectrogram of polyporenic acid C according to the present invention;

FIG. 25 is a mass spectrogram of quercetin according to the present invention;

FIG. 26 is a mass spectrogram of sophocarpine according to the present invention; and

FIG. 27 shows fingerprints of 15 batches of test articles based on Xin Su Ning capsules according to the present invention.

### DETAILED DESCRIPTION OF EMBODIMENTS

To further understand the present invention, the present invention is described below with reference to embodiments, which are only to further explain the features and advantages of the present invention and are not intended to limit the claims of the present invention.
1. A method for constructing a fingerprint of a Xin Su Ning capsule includes the following steps:
S1. Prepare a test article solution:

Precisely weigh 0.3 g to 1.0 g of contents of Xin Su Ning capsules of different batches, place the contents in a beaker flask with a stopper, add 20 mL to 30 mL of a methanol aqueous solution, perform ultrasonic extraction for 20 min to 40 min, and take a subsequent filtrate to pass through a 0.45-μm microporous filter membrane, to obtain the test article solution.
S2. Precisely suck 15 μL to 30 μL of the test article solution obtained in S1, inject the solution into a high performance liquid chromatograph, perform gradient elution, and record chromatograms from 0 to 140 min.
S3. Export the chromatograms obtained in S2, import the chromatograms into a traditional Chinese medicine chromatographic fingerprint similarity evaluation system (the 2004 A version), select chromatographic peaks that exist in all the chromatograms of the Xin Su Ning capsules of different batches as common peaks, perform data importing, multipoint correction, and data matching on the chromatograms of the test article solutions, to obtain a fingerprint, and perform similarity analysis, where a similarity is not less than 0.90.
S4. Perform mass spectral analysis on the foregoing test article solution to determine chemical constituents in the fingerprint, to obtain a total ion chromatogram, import detection data into Xcalibur software, enter a Qual Browser interface, and perform data analysis according to a peaking status of the chemical constituents.

A method for preparing the test article solution in the foregoing S1 is as follows: precisely weighing 0.5 g of contents of Xin Su Ning capsules of 15 batches, placing the contents in a beaker flask with a stopper, adding 25 mL of a 80% methanol aqueous solution, performing ultrasonic extraction for 30 min, and taking a subsequent filtrate to pass through a 0.45-μm microporous filter membrane, to obtain the test article solution.

In the foregoing S2, liquid-phase chromatographic conditions are: a chromatographic column: a Hedera ODS-2-C18 (250 mm×4.6 mm, 10 μm) chromatographic column; a mobile phase: acetonitrile (A) and a 0.1% formic acid aqueous solution (B); in gradient elution, a detection wavelength: 210 nm; a column temperature: 30° C.; a flow rate: 0.8 mL/min; a sample injection volume: 20 μL; and an elution procedure: 0 min, 20% A; 0-35 min, 20%-27% A; 35-45 min, 27%-35% A; 45-85 min, 35-45% A; 85-90 min, 45-65% A; and 90-140 min, 65-100% A.
2. Optimization of fingerprint detection

### S1: Optimization of an Extraction Method

In the present invention, experimental comparison is performed by using different extraction methods (ultrasonic, 20 min; ultrasonic, 30 min; and backflow: 60 min) and different extraction solvents (ultrapure water, a 80% methanol aqueous solution, and methanol). It is found out through results that a chromatogram obtained through 30-min ultrasonic extraction cover constituents relatively comprehensively, and the resolution is good. Therefore, a method of 30-min ultrasonic extraction is used. It is found out in the inspection of extraction solvents that a chromatogram of an extractive of a 80% methanol aqueous solution has the largest amount of information, and the contents of the constituents are the highest. Therefore, a 80% methanol aqueous solution is chosen to perform extraction.

### S2. Optimization in a Chromatographic Condition Aspect

In the present invention, an ultraviolet-visible absorption detector is used to perform inspection on detection wavelengths (210 nm, 254 nm, 275 nm, and 300 nm). It is found out that when a detection wavelength condition is 210 nm, the chromatogram contains the most comprehensive information, and the baseline is smooth. Therefore, this method is selected as the detection wavelength condition.

In the present invention, flow rates (0.6 mL/min, 0.8 mL/min, and 1.0 mL/min) are filtered. It is found out that when the flow rate is 0.8 mL/min, the effect of separating substances is good, and the resolution is the highest. Therefore, a flow rate of 0.8 mL/min is used.

In the present invention, temperatures (25° C., 30° C., and 35° C.) are filtered. It is found out that the temperature has a slight impact on a peaking time and a peaking quantity, and the effect of separating substances is good. Therefore, a temperature of 30° C. is chosen.

In the present invention, elution effect of a plurality of different elution systems of acetonitrile-water, methanol-water, acetonitrile-0.2% phosphoric acid-water, acetonitrile-0.1% formic acid, and acetonitrile-0.1% glacial acetic acid at different gradients is compared. It is found out through the results that when acetonitrile and a 0.1% formic acid aqueous solution are used as a mobile phase, constituents in the Xin Su Ning capsule have a good peaking status, and the effect of separating the constituents is adequate. Therefore, acetonitrile and a 0.1% formic acid aqueous solution are finally selected as a mobile phase.

After an optimal mobile phase composition is determined, in the present invention, a large number of experiments are performed to filter out an optimal gradient elution procedure. It is found out through experiments that when a 20% volume of acetonitrile at 0 min, a 20%-27% volume of acetonitrile from 0 to 35 min, a 27%-35% volume of acetonitrile from 35 min to 45 min, a 35%-45% volume of acetonitrile from 45 min to 85 min, a 45%-65% volume of acetonitrile from 85 min to 90 min, and a 65%-100% volume of acetonitrile from 90 min to 140 min is used, good resolution of chromatographic peaks in the fingerprint can be implemented.

Instruments used in the present invention are shown in the following Table 1, reagents used in the present invention are shown in the following Table 2, and drugs used in the present invention are shown in the following Table 3.

TABLE 1
Instruments used in the present invention

| Instrument name | Model | Manufacturer |
|---|---|---|
| High performance | LC-16 | Shimadzu (China) |
| liquid chromatograph | | |
| Chromatographic | Hedera ODS-2-C18 | Elitehplc |
| column | KromasiL100-5-C18 | AkzoNobel |
| | NewmateTM C18 | Welch |
| Electronic balance | JA2603B | Techcomp Instruments |
| | | (Shanghai) Co., Ltd. |
| Ultrasonic cleaner | YM-100 (44 KHz) | Shenzhen Fangao |
| | | Microelectronics Co., Ltd. |
| Ultrapure water | Millipore Milli-v | Millipore, Bedford, MA, |
| preparation system | Plus | USA |
| Digital display | | Jiangnan Instrument |
| thermostatic water | | Factory (Jintan) |
| bath HH-8 cauldron | | |

TABLE 2
Reagents used in the present invention

| Name | Batch No./Purity | Manufacturer |
|---|---|---|
| Methanol | Chromatogram is pure | Fisher Scientific |
| Acetonitrile | Chromatogram is pure | Fisher Scientific |
| Formic acid | Chromatogram is pure | Tianjin Tianli Chemical Reagents |
| | | Co., Ltd. |
| Methanol | Analytically pure | Methanol |

TABLE 3
Drugs used in the present invention

| Name | Batch | Manufacturer |
|---|---|---|
| Xin Su Ning capsule | Batch 1 | Shaanxi Momentum Qixuehe |
| | Batch 2 | Pharmaceutical Co., Ltd. |
| | Batch 3 | |
| | Batch 4 | |
| | Batch 5 | |
| | Batch 6 | |
| | Batch 7 | |
| | Batch 8 | |
| | Batch 9 | |
| | Batch 10 | |
| | Batch 11 | |
| | Batch 12 | |
| | Batch 13 | |
| | Batch 14 | |
| | Batch 15 | |

The implementations of the present invention are described below in detail with reference to specific embodiments.

### Embodiment 1

A method for constructing a fingerprint of a Xin Su Ning capsule includes the following steps:

### S1. Prepare a Test Article Solution

Precisely weigh 0.5 g of contents of Xin Su Ning capsules, place the contents in a beaker flask with a stopper, add 25 mL of a methanol aqueous solution, perform ultrasonic extraction for 30 min, and take a subsequent filtrate to pass through a 0.45-μm microporous filter membrane, to obtain the test article solution.

### S2. Chromatographic Conditions

A chromatographic column: a Hedera ODS-2-C18 (250 mm×4.6 mm, 5 μm) chromatographic column; a mobile phase: acetonitrile and a 0.1% formic acid aqueous solution; in gradient elution, a detection wavelength: 210 nm/254 nm/270 nm/300 nm; a column temperature: 30° C.; a flow rate: 0.8 mL/min; a sample injection volume: 20 μL; and an elution procedure is shown in the following Table 4.

TABLE 4
Embodiment 1: Elution procedure

| Time (min) | Volume (%) of acetonitrile |
|---|---|
| 0-20 | 10-25 |
| 20-65 | 25-40 |
| 65-90 | 40-75 |
| 90-110 | 75-85 |
| 110-120 | 85 |

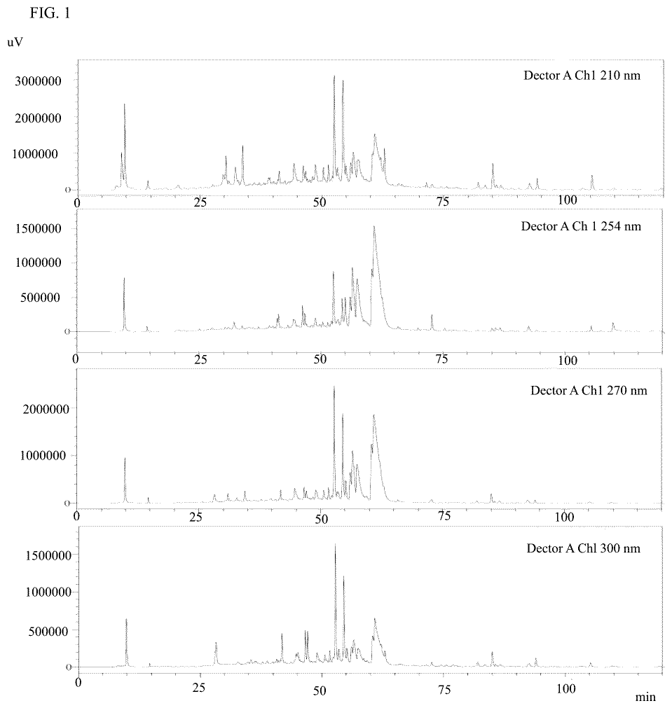

For final experimental results, see FIG. 1. As can be seen from the chromatogram, under four detection wavelengths, the overall resolution is poor, and a few of peaks exist from 0 min to 255 min. However, when the detection wavelength is 210 nm, a peaking status from 25 min to 40 min is better than those in other periods. Therefore, 210-nm detection is used in a subsequent optimization process.

### Embodiment 2

A method for constructing a fingerprint of a Xin Su Ning capsule includes the following steps:

### S1. Prepare a Test Article Solution

Precisely weigh 0.5 g of contents of Xin Su Ning capsules, place the contents in a beaker flask with a stopper, add 25 mL of a methanol aqueous solution, perform ultrasonic extraction for 30 min, and take a subsequent filtrate to pass through a 0.45-μm microporous filter membrane, to obtain the test article solution.

### S2. Chromatographic Conditions

A chromatographic column: a Hedera ODS-2-C18 (250 mm×4.6 mm, 5 μm) chromatographic column; a mobile phase: acetonitrile and a 0.1% formic acid aqueous solution; in gradient elution, a detection wavelength: 210 nm; a column temperature: 30° C.; a flow rate: 0.6 mL/min, 0.8 mL/min, and 1 mL/min; a sample injection volume: 20 μL; and an elution procedure is shown in the following Table 5.

TABLE 5
Embodiment 2: Elution procedure

| Time (min) | Volume (%) of acetonitrile |
|---|---|
| 0-10 | 10-21 |
| 10-15 | 21-27 |
| 15-30 | 27-35 |
| 30-70 | 35-51 |
| 70-90 | 51-70 |
| 90-120 | 70-90 |

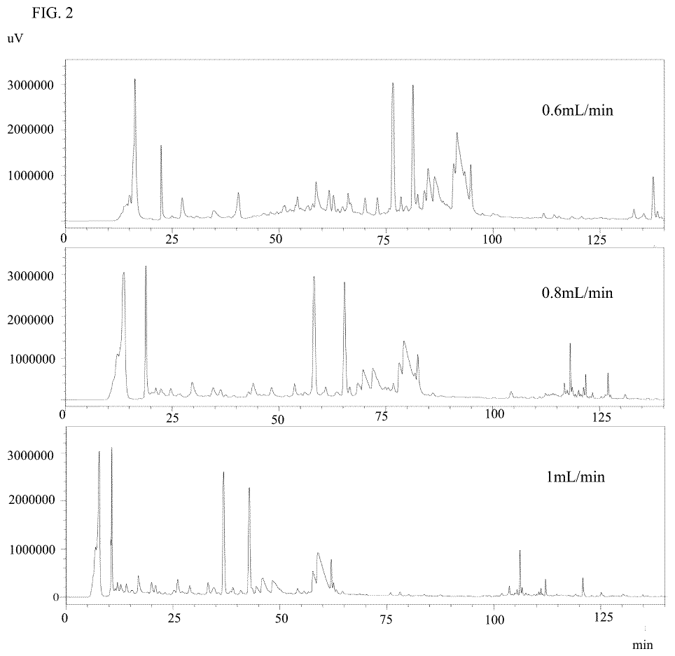

For final experimental results, see FIG. 2. As can be seen from the chromatogram, when the flow rate is 0.6 mL/min, a peaking quantity is large. However, the resolution between adjacent peaks is low, and peaking is not complete after 125 min. When the flow rate is 1 mL/min, a peaking quantity is small, and there are peaks missing from 75 min to 100 min, and a fingerprint requirement cannot be met. When the flow rate is 0.8 mL/min, the chromatogram has both an adequate peaking status and adequate good resolution. Therefore, a flow rate of 0.8 mL/min is selected in subsequent embodiments.

### Embodiment 3

A method for constructing and detecting a fingerprint of a Xin Su Ning capsule includes the following steps:

### S1. Prepare a Test Article Solution

Precisely weigh 0.5 g of contents of Xin Su Ning capsules, place the contents in a beaker flask with a stopper, add 25 mL of a 80% methanol aqueous solution, perform ultrasonic extraction for 30 min, and take a subsequent filtrate to pass through a 0.45-μm microporous filter membrane, to obtain the test article solution.

### S2. Chromatographic Conditions

A chromatographic column: a Hedera ODS-2-C18 (250 mm×4.6 mm, 5 μm) chromatographic column; a mobile phase: acetonitrile and a 0.1% formic acid aqueous solution; in gradient elution, a detection wavelength: 210 nm; a column temperature: 30° C.; a flow rate: 0.8 mL/min; a sample injection volume: 20 μL; and an elution procedure is shown in the following Table 6.

TABLE 6
Embodiment 3: Elution procedure

| Time (min) | Volume (%) of acetonitrile |
|---|---|
| 0-10 | 10-21 |
| 10-15 | 21-27 |
| 15-30 | 27-35 |
| 30-70 | 35-51 |
| 70-90 | 51-70 |
| 90-120 | 70-90 |

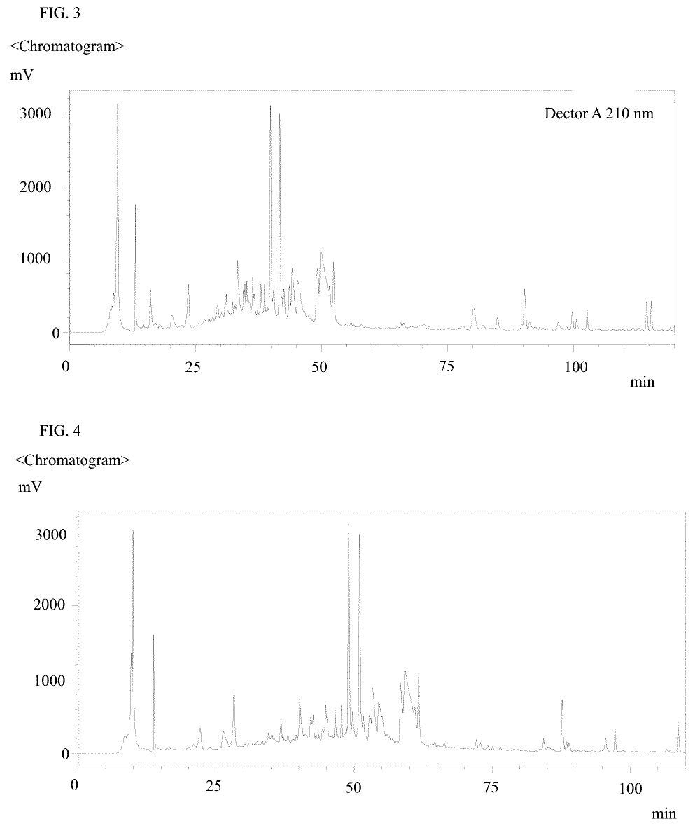

For final experimental results, see FIG. 3. As can be seen from the chromatogram, the overall resolution is poor. A few of peaks exist from 55 min to 75 min, and contents are not high. A lot of peaks exist from 30 min to 45 min. However, a peak density is larger. In optimization, it may be continued to focus on stretching peaks in this period of time. In consideration of impacts of concentrations of a mobile phase and an organic phase on peak spacings, a concentration gradient continues to be optimized.

### Embodiment 4

A method for constructing a fingerprint of a Xin Su Ning capsule includes the following steps:

### S1. Prepare a Test Article Solution

Precisely weigh 0.5 g of contents of Xin Su Ning capsules, place the contents in a beaker flask with a stopper, add 25 mL of a 80% methanol aqueous solution, perform ultrasonic extraction for 30 min, and take a subsequent filtrate to pass through a 0.45-μm microporous filter membrane, to obtain the test article solution.

### S2. Chromatographic Conditions

A chromatographic column: a Hedera ODS-2-C18 (250 mm×4.6 mm, 5 μm) chromatographic column; a mobile phase: acetonitrile and a 0.1% formic acid aqueous solution; in gradient elution, a detection wavelength: 210 nm; a column temperature: 30° C.; a flow rate: 0.8 ml/min; a sample injection volume: 20 μL; and an elution procedure is shown in the following Table 7.

TABLE 7
Embodiment 4: Elution procedure

| Time (min) | Volume (%) of acetonitrile |
|---|---|
| 0-20 | 8-23 |
| 20-35 | 23-27 |
| 35-40 | 27-33 |
| 40-45 | 33-43 |
| 45-65 | 43-50 |
| 65-85 | 50-70 |
| 85-120 | 70-88 |

For final experimental results, see FIG. 4. As can be seen from the chromatogram, the separation effect from 30 min to 50 min is moderately improved. However, the overall resolution still fails to meet a fingerprint requirement, and a concentration gradient continues to be optimized.

### Embodiment 5

A method for constructing a fingerprint of a Xin Su Ning capsule includes the following steps:

### S1. Prepare a Test Article Solution

Precisely weigh 0.5 g of contents of Xin Su Ning capsules, place the contents in a beaker flask with a stopper, add 25 mL of a 80% methanol aqueous solution, perform ultrasonic extraction for 30 min, and take a subsequent filtrate to pass through a 0.45-μm microporous filter membrane, to obtain the test article solution.

### S2. Chromatographic Conditions

A chromatographic column: a Hedera ODS-2-C18 (250 mm×4.6 mm, 5 μm) chromatographic column; a mobile phase: acetonitrile and a 0.1% formic acid aqueous solution; in gradient elution, a detection wavelength: 210 nm; a column temperature: 30° C.; a flow rate: 0.8 mL/min; a sample injection volume: 20 μL; and an elution procedure is shown in the following Table 8.

TABLE 8
Embodiment 5: Elution procedure

| Time (min) | Volume (%) of acetonitrile |
|---|---|
| 0-35 | 20-25 |
| 35-90 | 25-40 |
| 90-110 | 40-85 |
| 110-120 | 85-90 |

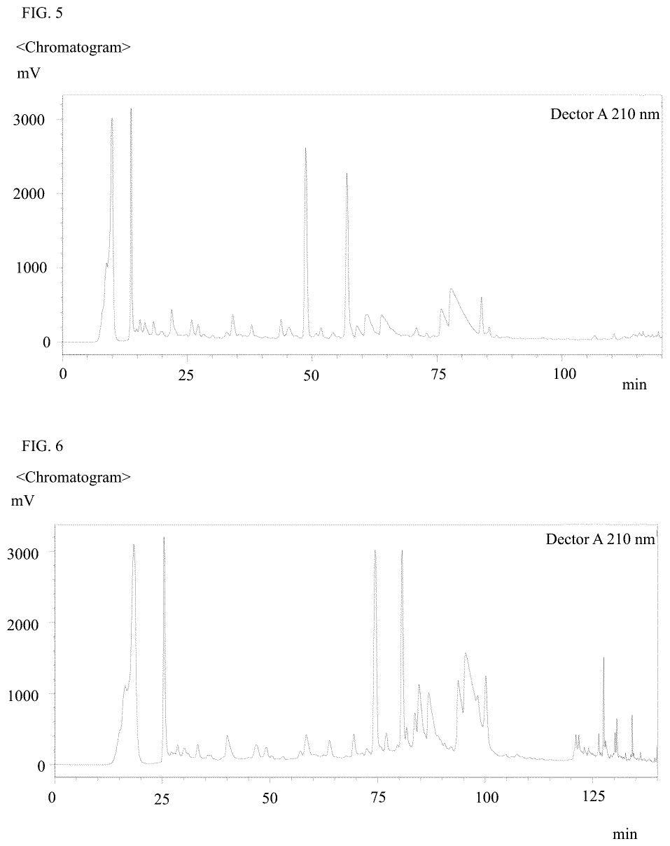

For final experimental results, see FIG. 5. As can be seen from the chromatogram, the overall peaking status is adequate, and the resolution of chromatographic peaks is slightly improved. However, peaking after 120 min is not complete, a concentration gradient continues to be optimized, and an elution time is extended.

### Embodiment 6

A method for constructing a fingerprint of a Xin Su Ning capsule includes the following steps:

### S1. Prepare a Test Article Solution

Precisely weigh 0.5 g of contents of Xin Su Ning capsules, place the contents in a beaker flask with a stopper, add 25 mL of a 80% methanol aqueous solution, perform ultrasonic extraction for 30 min, and take a subsequent filtrate to pass through a 0.45-μm microporous filter membrane, to obtain the test article solution.

### S2. Chromatographic Conditions

A chromatographic column: a Hedera ODS-2-C18 (250 mm×4.6 mm, 5 μm) chromatographic column; a mobile phase: acetonitrile and a 0.1% formic acid aqueous solution; in gradient elution, a detection wavelength: 210 nm; a column temperature: 30° C.; a flow rate: 0.8 mL/min; a sample injection volume: 20 μL; and an elution procedure is shown in the following Table 9.

TABLE 9
Embodiment 2: Elution procedure

| Time (min) | Volume (%) of acetonitrile |
|---|---|
| 0-35 | 20-27 |
| 35-45 | 27-35 |
| 45-85 | 35-45 |
| 85-90 | 45-90 |
| 90-140 | 90-100 |

For final experimental results, see FIG. 6. As can be seen from the chromatogram, a peaking status after 100 min is moderately improved. However, the peaking is dense, and the resolution is poor. In consideration of impacts of concentrations of a mobile phase and an organic phase on peak spacings, a concentration gradient continues to be optimized.

### Embodiment 7

A method for constructing a fingerprint of a Xin Su Ning capsule includes the following steps:
S1. Prepare a test article solution:

Precisely weigh 0.5 g of contents of Xin Su Ning capsules of 15 batches, place the contents in a beaker flask with a stopper, add 25 mL of a 80% methanol aqueous solution, perform ultrasonic extraction for 30 min, and take a subsequent filtrate to pass through a 0.45-μm microporous filter membrane, to obtain the test article solution.
S2. Chromatographic conditions

A chromatographic column: a Hedera ODS-2-C18 (250 mm×4.6 mm, 5 μm) chromatographic column; a mobile phase: acetonitrile and a 0.1% formic acid aqueous solution; in gradient elution, a 210 nm; a column temperature: 30° C.; a flow rate: 0.8 mL/min; a sample injection volume: 20 μL; and an elution procedure is shown in the following Table 10.

TABLE 10
Embodiment 7: Elution procedure

| Time (min) | Volume (%) of acetonitrile |
|---|---|
| 0-35 | 20-27 |
| 25-45 | 27-35 |
| 45-85 | 35-45 |
| 85-95 | 45-65 |
| 95-140 | 65-100 |

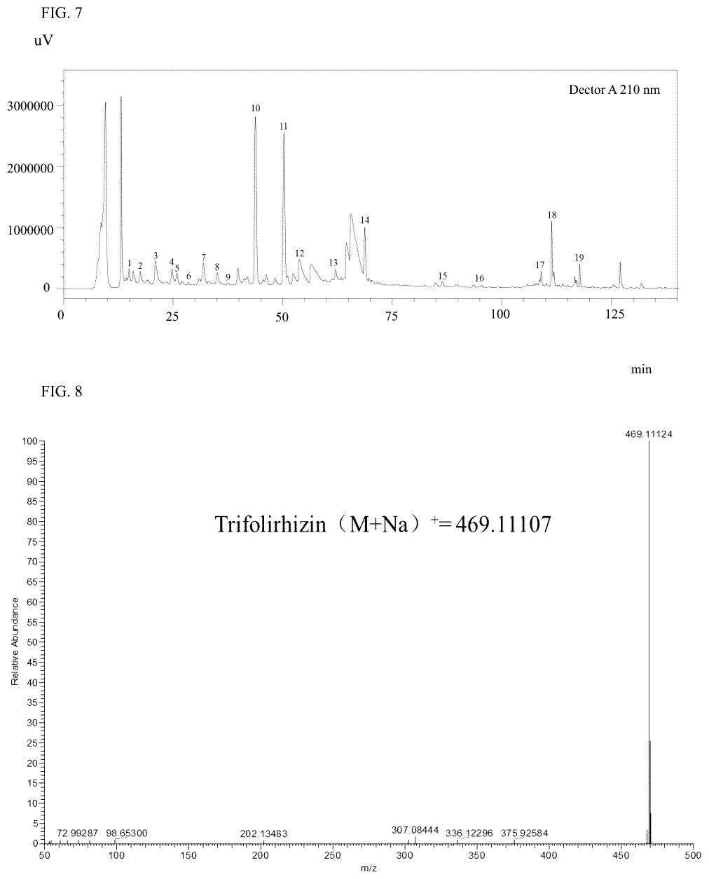

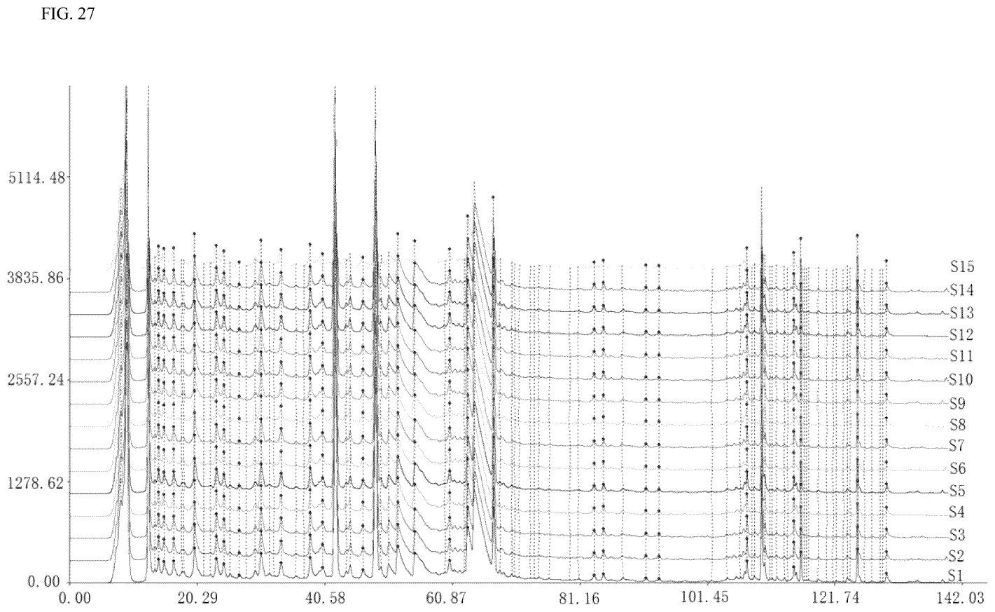

For a final obtained chromatogram, see FIG. 7. In the chromatogram obtained in the elution procedure in this embodiment, the peaking status is adequate, the resolution is good, and a requirement of establishing a fingerprint is met. Therefore, the method is finally chosen as a method for establishing a fingerprint of a Xin Su Ning capsule, and subsequent peak recognition, similarity analysis, and methodological inspection are performed.
S3. Export the chromatograms of the test article solutions of the Xin Su Ning capsule obtained in S2, import the chromatograms into a traditional Chinese medicine chromatographic fingerprint similarity evaluation system (the 2004 A version), perform data importing, multipoint correction, and data matching on the chromatograms of the test article solutions, to obtain a fingerprint (FIG. 27), and perform similarity analysis (Table 11).

TABLE 11
Similarities between samples of different batches and a common mode

| | S1 | S2 | S3 | S4 | S5 | S6 | S7 | S8 | S9 | S10 | S11 | S12 | S13 | S14 | S15 |
|---|---|---|---|---|---|---|---|---|---|---|---|---|---|---|---|
| S1 | 1 | 0.987 | 0.996 | 0.934 | 0.952 | 0.971 | 0.948 | 0.981 | 0.959 | 0.996 | 0.967 | 0.988 | 0.967 | 0.999 | 0.983 |
| S2 | 0.987 | 1 | 0.971 | 0.978 | 0.969 | 0.997 | 0.985 | 0.968 | 0.997 | 0.996 | 0.967 | 0.995 | 0.982 | 0.976 | 0.968 |
| S3 | 0.996 | 0.971 | 1 | 0.978 | 0.948 | 0.974 | 0.981 | 0.997 | 0.965 | 0.985 | 0.069 | 0.971 | 0.989 | 0.963 | 0.985 |
| S4 | 0.934 | 0.978 | 0.978 | 1 | 0.986 | 0.946 | 0.971 | 0.996 | 0.993 | 0.987 | 0.971 | 0.984 | 0.999 | 0.968 | 0.959 |
| S5 | 0.952 | 0.969 | 0.948 | 0.986 | | 10.996 | 0.986 | 0.981 | 0.978 | 0.975 | 0.982 | 0.975 | 0.991 | 0.972 | 0.988 |
| S6 | 0.971 | 0.997 | 0.974 | 0.946 | 0.996 | 1 | 0.999 | 0.981 | 0.994 | 0.989 | 0.979 | 0.981 | 0.977 | 0.978 | 0.995 |
| S7 | 0.948 | 0.985 | 0.981 | 0.971 | 0.986 | 0.999 | 1 | 0.985 | 0.947 | 0.987 | 0.992 | 0.999 | 0.972 | 0.984 | 0.978 |
| S8 | 0.981 | 0.968 | 0.997 | 0.996 | 0.981 | 0.985 | 1 | | 0.957 | 0.976 | 0.968 | 0.979 | 0.985 | 0.979 | 0.978 |
| S9 | 0.959 | 0.997 | 0.965 | 0.993 | 0.978 | 0.994 | 0.947 | 0.957 | 1 | 0.966 | 0.976 | 0.978 | 0.994 | 0.975 | 0.981 |
| S10 | 0.996 | 0.996 | 0.985 | 0.987 | 0.975 | 0.989 | 0.987 | 0.976 | 0.966 | 1 | 0.966 | 0.958 | 0.975 | 0.986 | 0.984 |
| S11 | 0.967 | 0.967 | 0.069 | 0.971 | 0.982 | 0.979 | 0.992 | 0.968 | 0.976 | 0.966 | 1 | 0.986 | 0.977 | 0.956 | 0.971 |
| S12 | 0.988 | 0.995 | 0.971 | 0.984 | 0.975 | 0.981 | 0.999 | 0.979 | 0.978 | 0.958 | 0.986 | 1 | 0.974 | 0.988 | 0.997 |
| S13 | 0.967 | 0.982 | 0.989 | 0.999 | 0.991 | 0.977 | 0.972 | 0.985 | 0.994 | 0.975 | 0.977 | 0.974 | 1 | 0.982 | 0.965 |
| S14 | 0.999 | 0.976 | 0.963 | 0.968 | 0.972 | 0.978 | 0.984 | 0.979 | 0.975 | 0.986 | 0.956 | 0.988 | 0.982 | 1 | 0.995 |
| S15 | 0.983 | 0.968 | 0.985 | 0.959 | 0.988 | 0.995 | 0.978 | 0.978 | 0.981 | 0.984 | 0.971 | 0.997 | 0.965 | 0.995 | 1 |

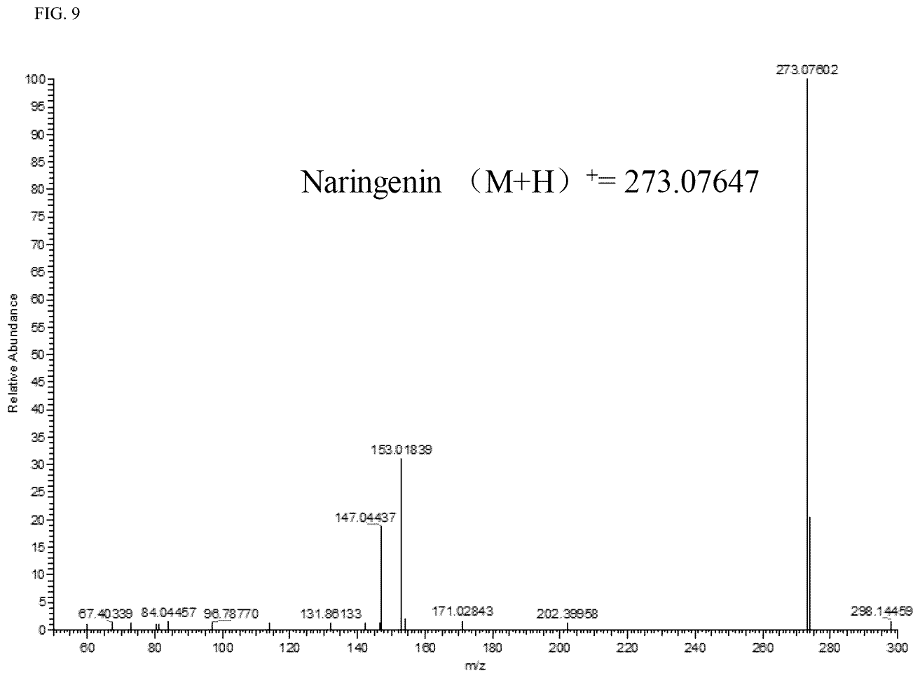

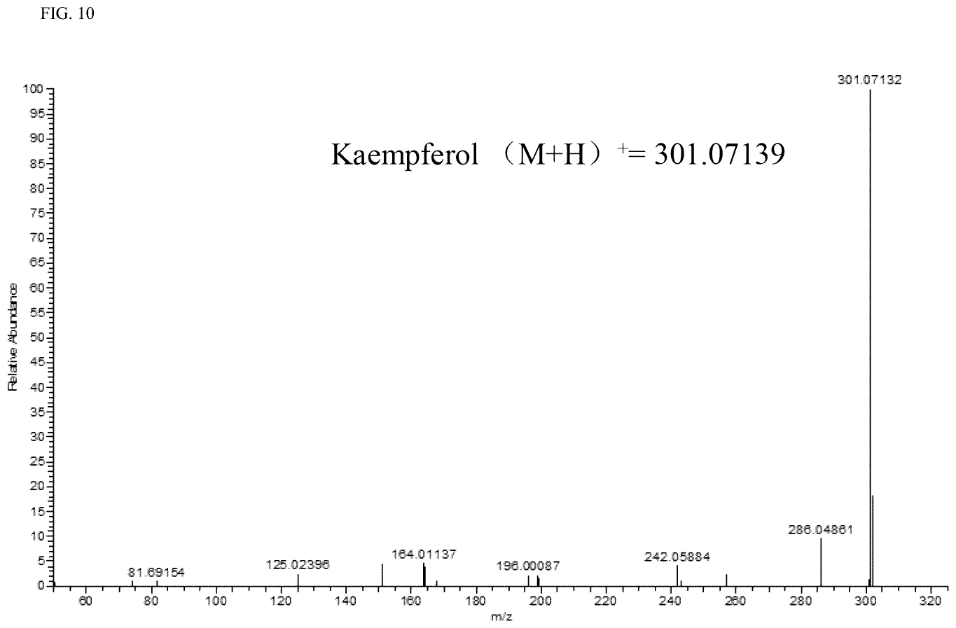

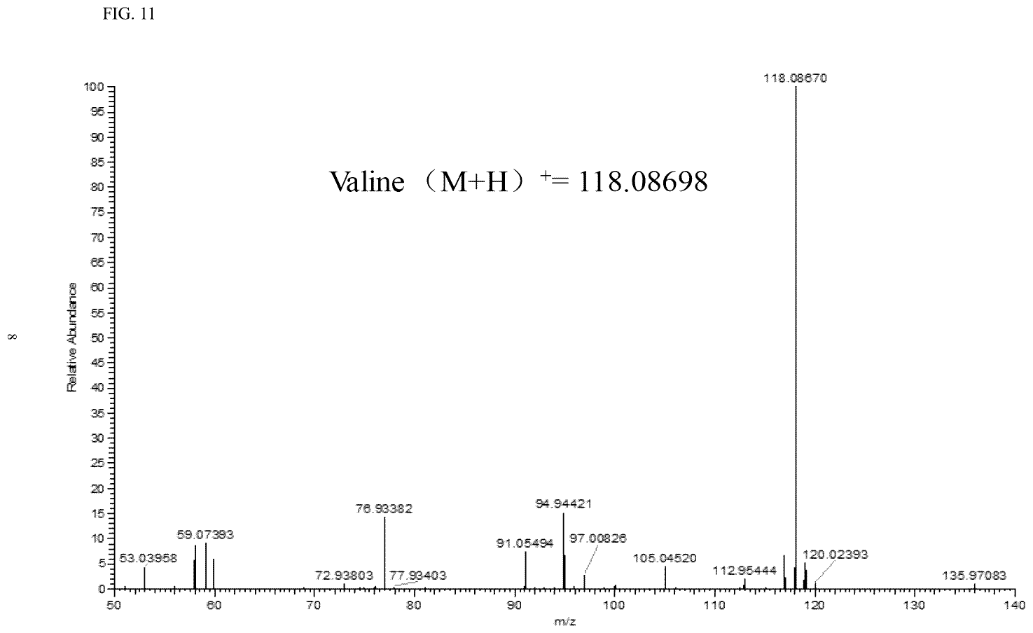

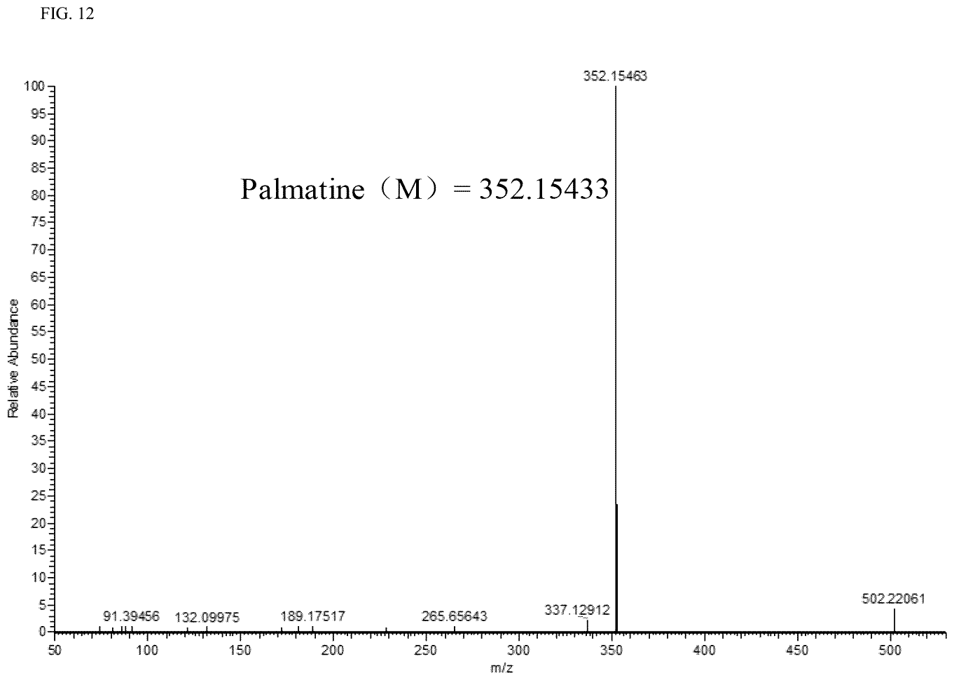

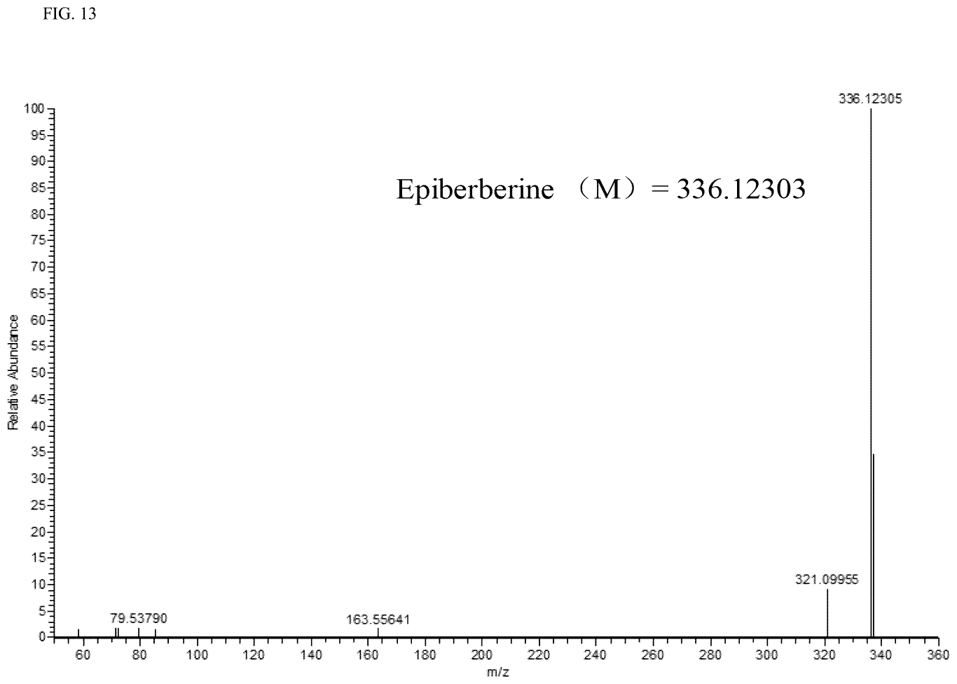

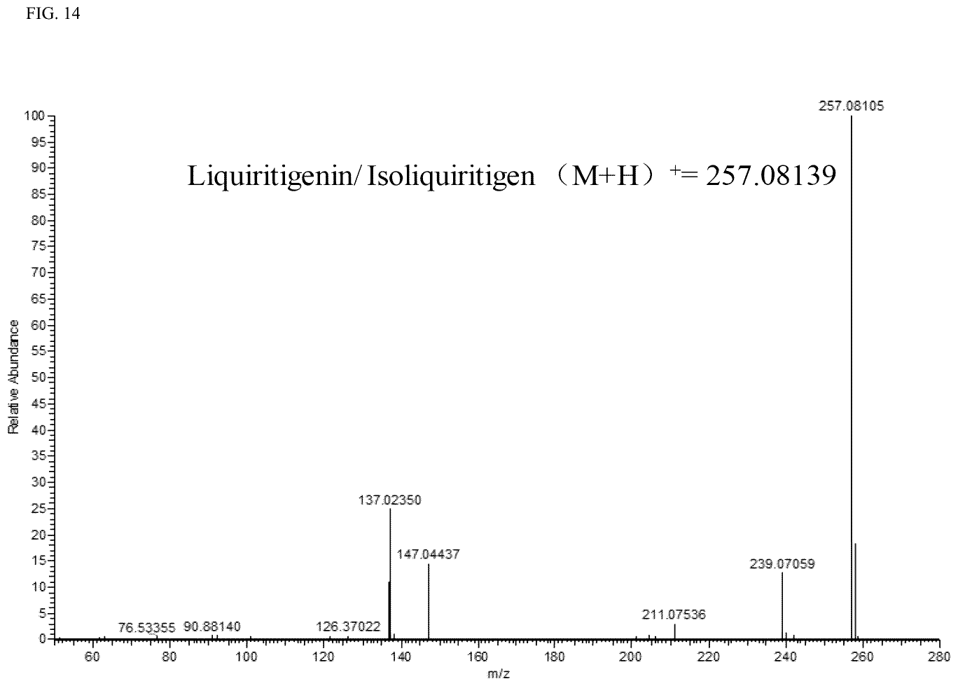

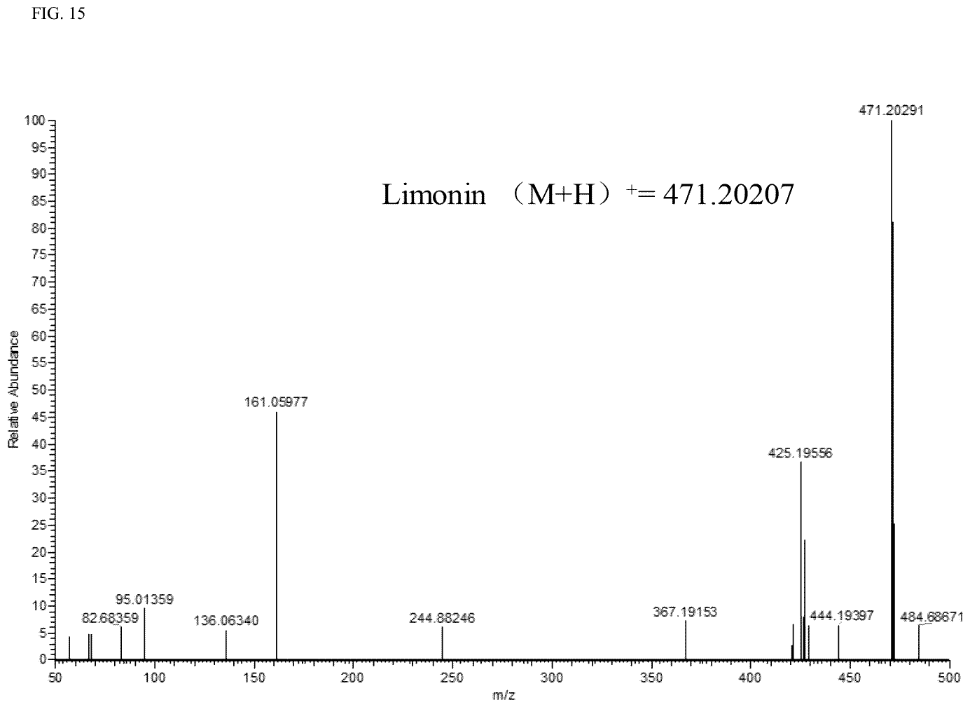

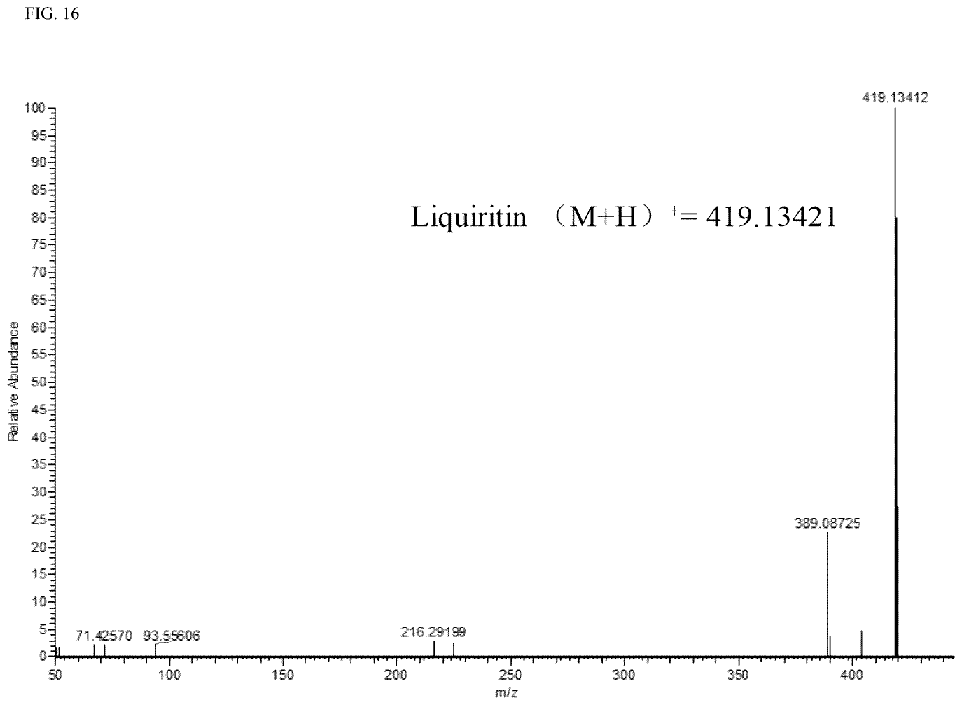

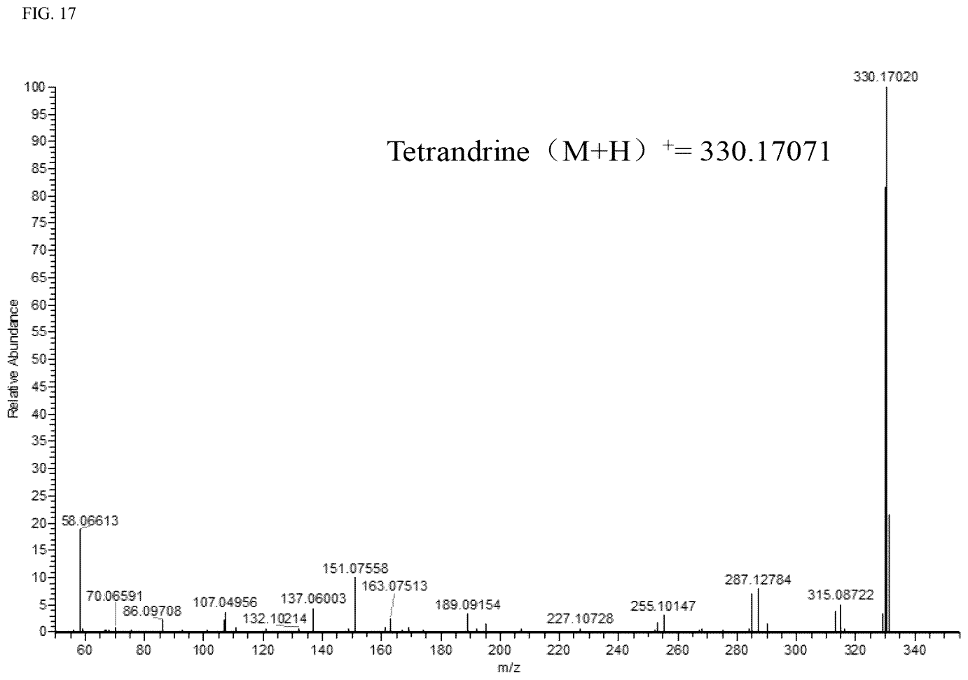

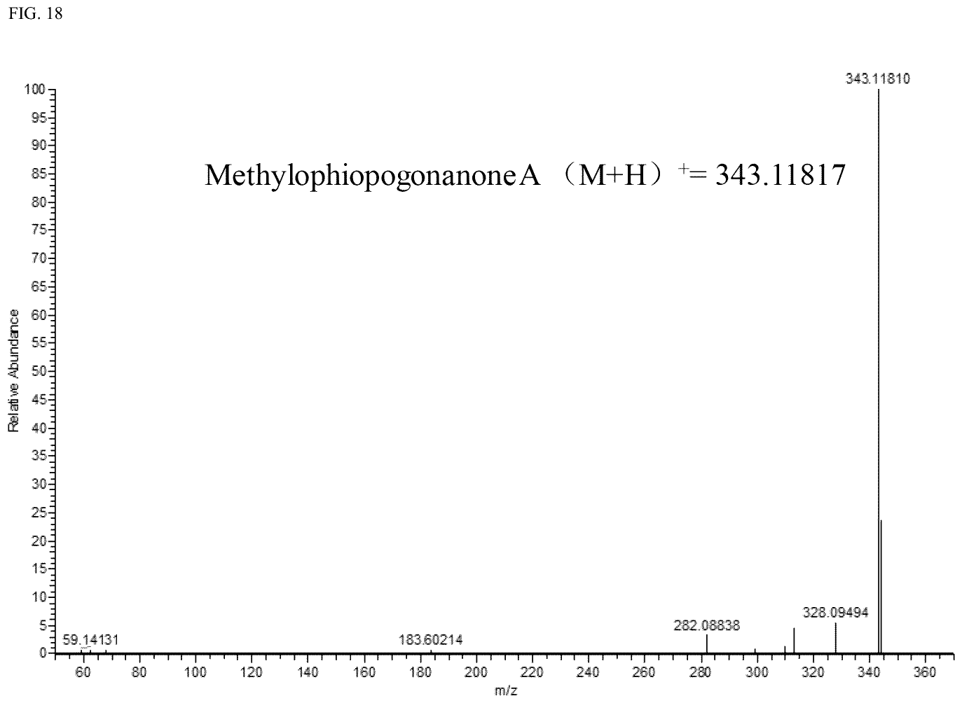

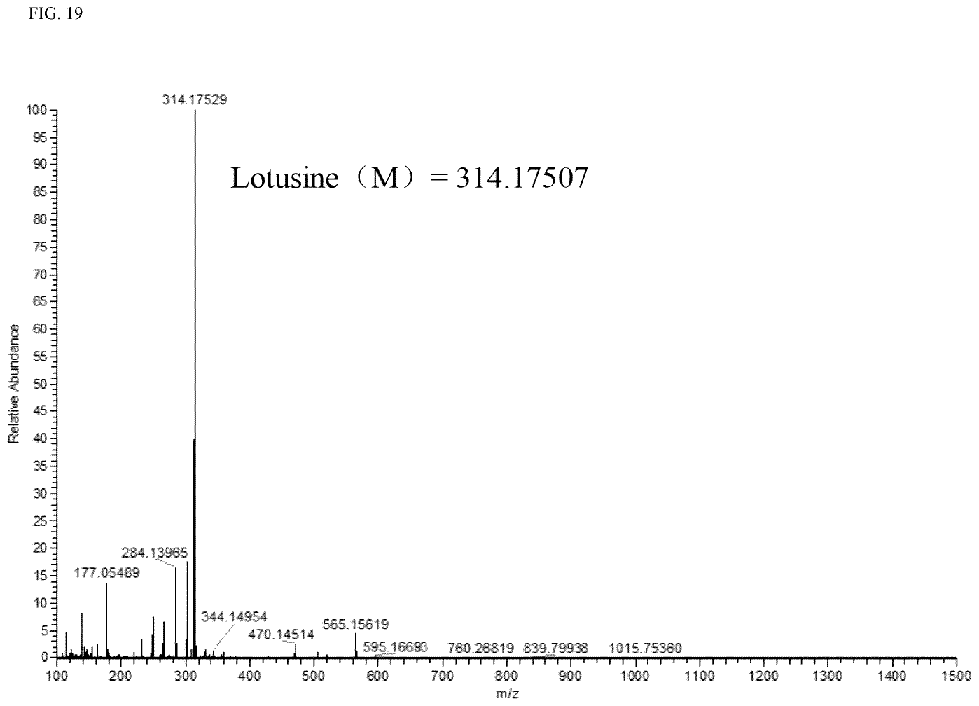

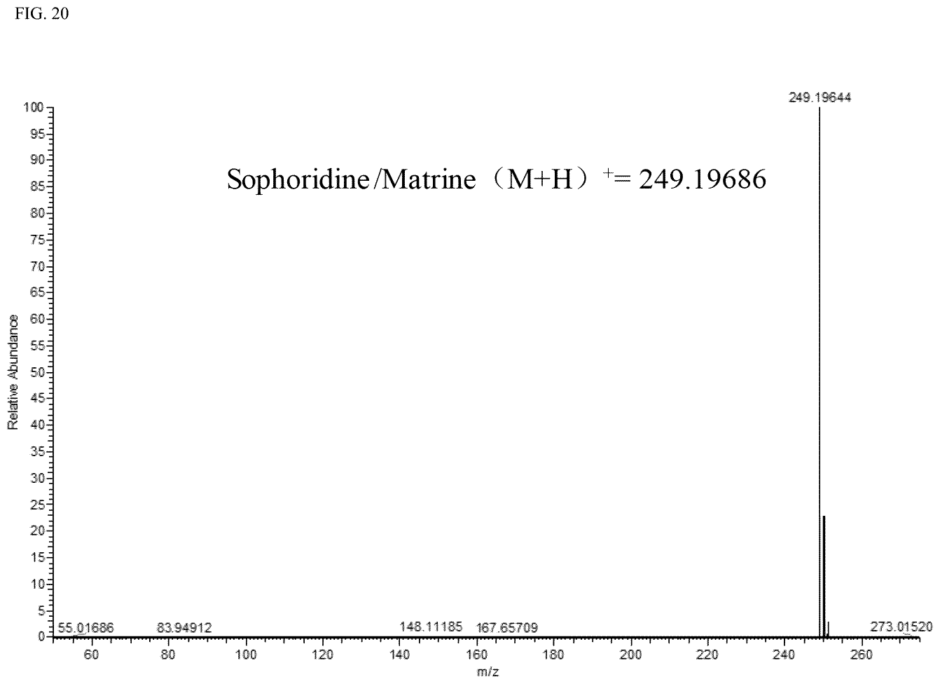

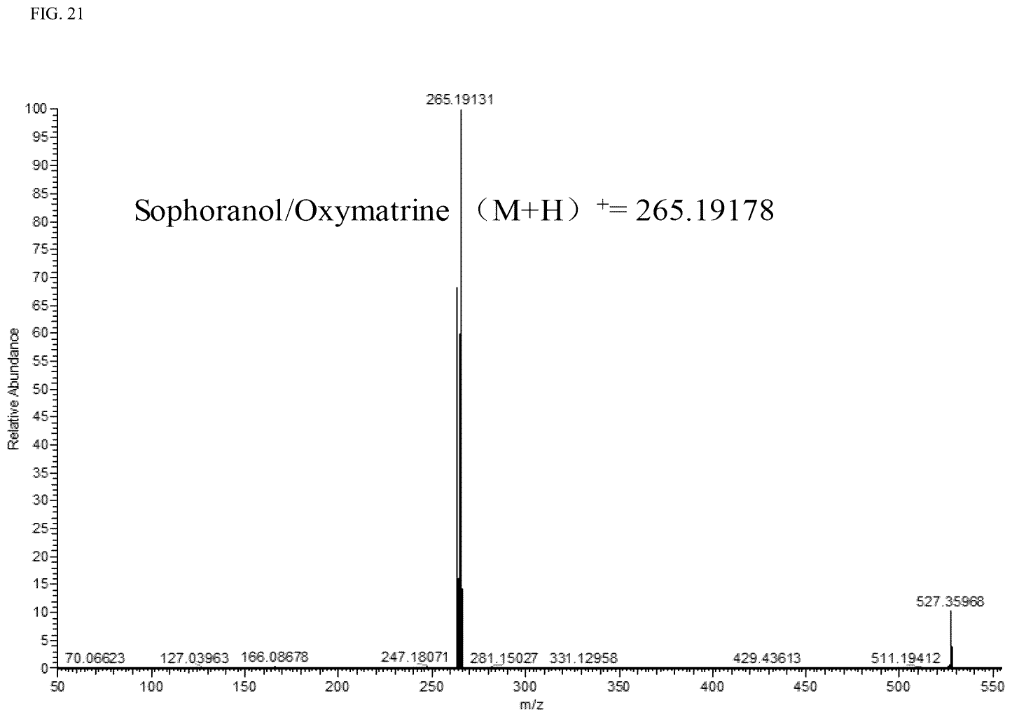

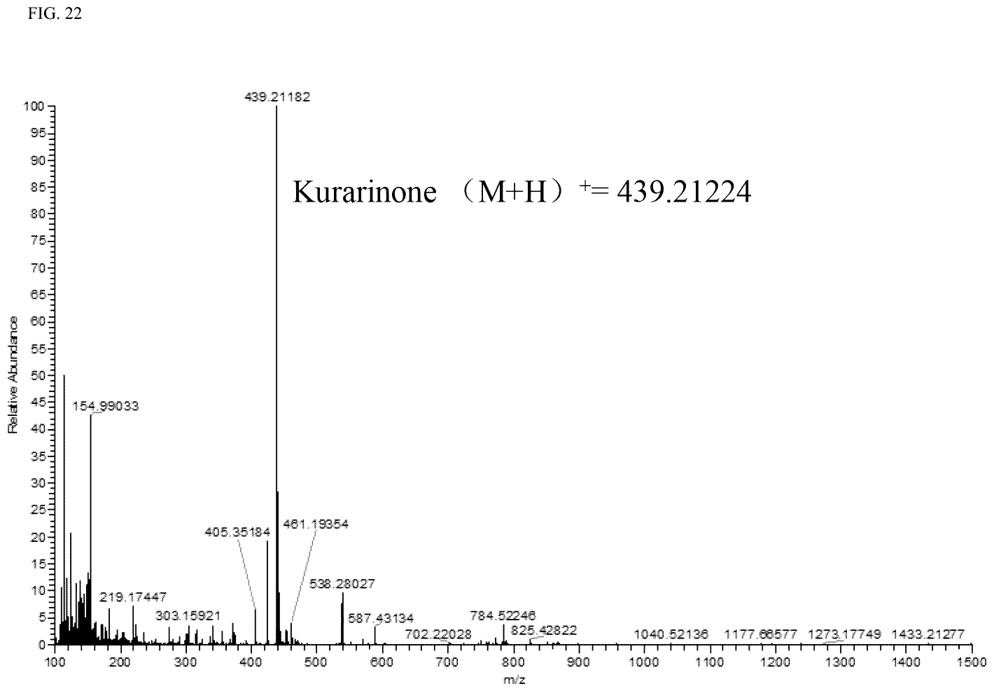

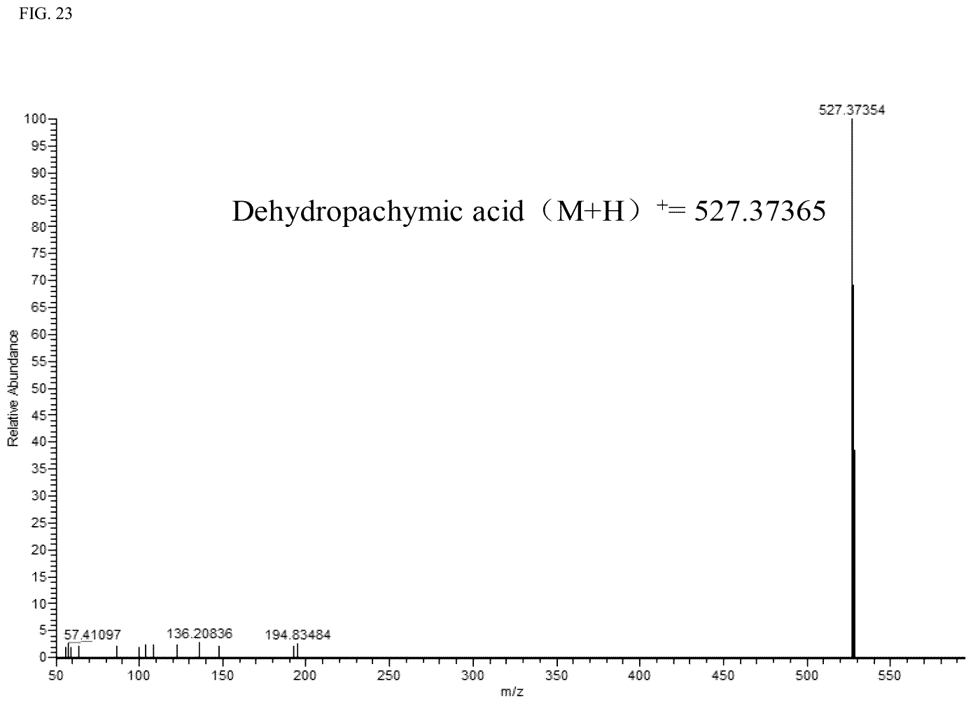

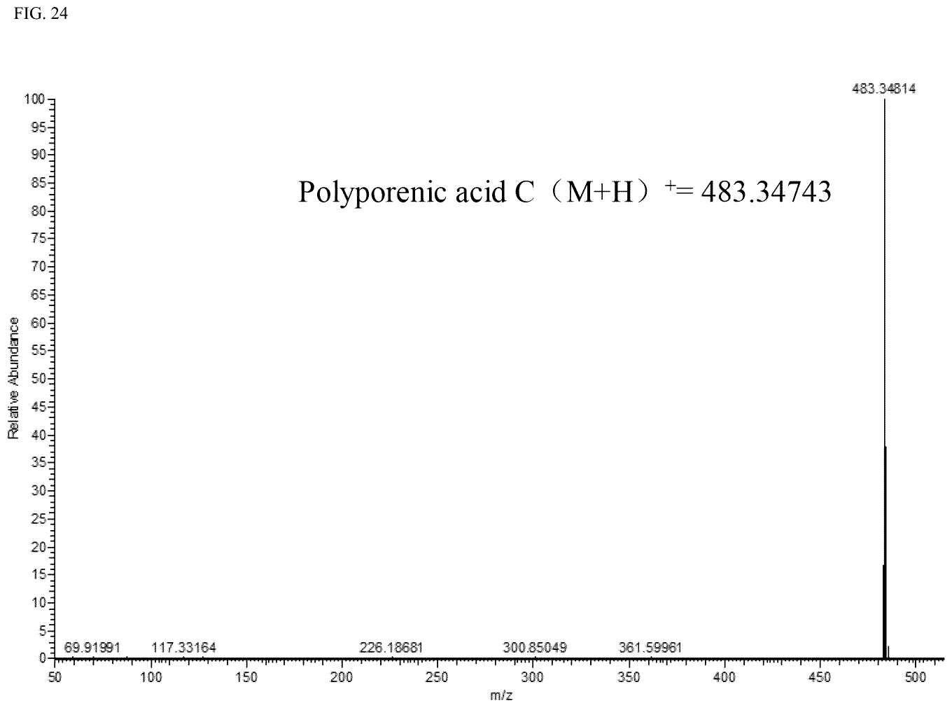

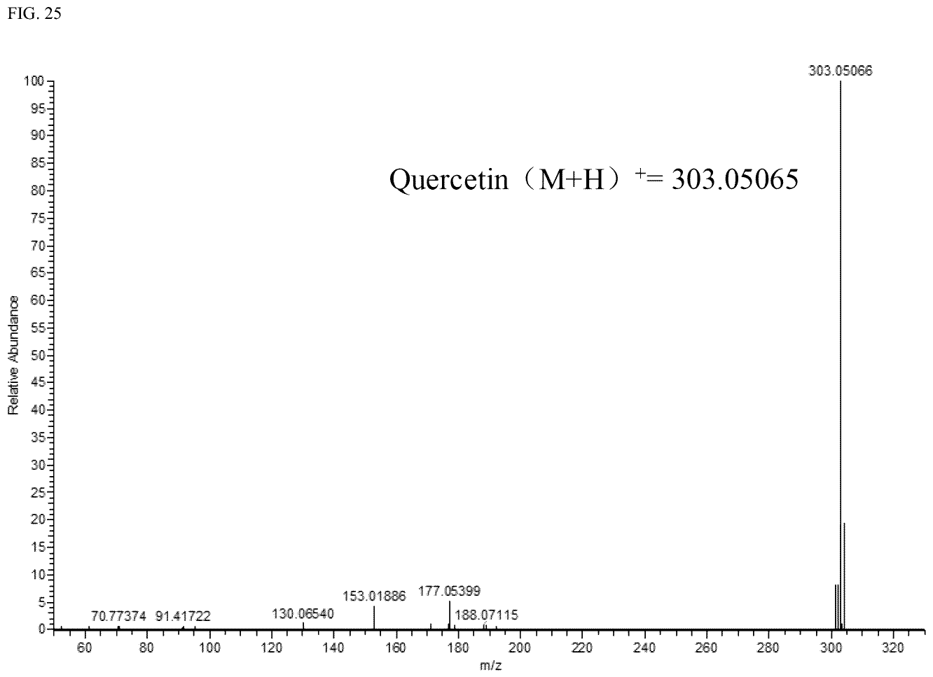

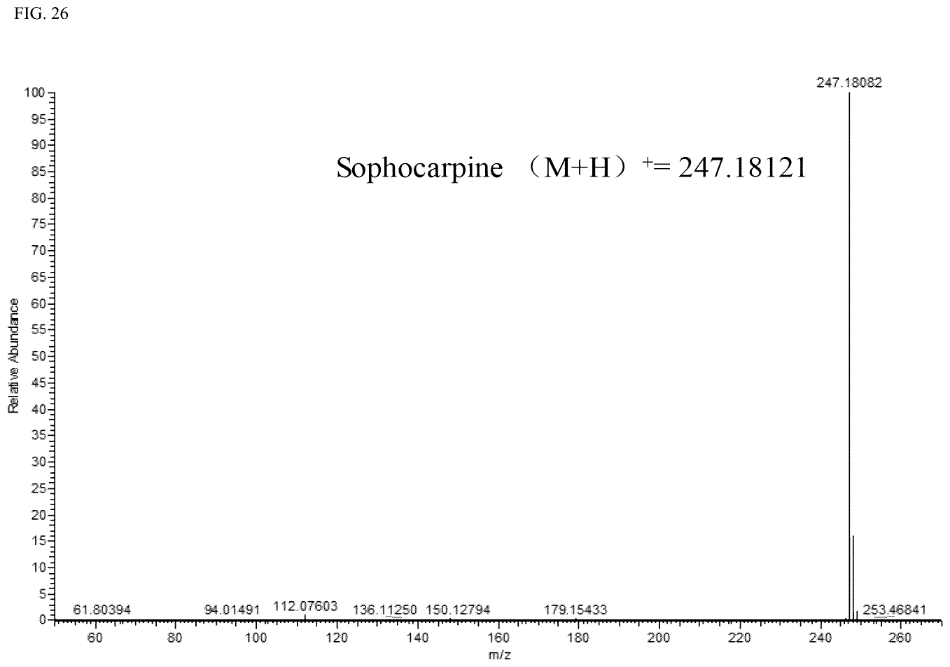

S4. Perform mass spectral analysis on the foregoing test article solution to determine chemical constituents in the fingerprint, where used instruments are: a Thermo Scientific Ultimate 3000 RSLC ultrahigh performance liquid chromatograph-Thermo Scientific Q Exactive Focus desktop high-resolution mass spectroscope. A mass spectral condition is electrospray ionization (electrospray ionization, ESI), a spray voltage is 3800 V, a sheath gas flow rate is 45 arb, an auxiliary gas flow rate is 10 arb, a capillary temperature is 350° C., a mass-to-charge ratio scan range m/z is 100-1200, and a scan mode is a full-scan mode, to obtain a total ion chromatogram and mass spectral result diagrams (FIG. 8 to FIG. 26) of 19 chemical constituents, import detection data into Xcalibur software, enter a Qual Browser interface, and perform data analysis according to a peaking status of the chemical constituents. The chemical constituents are respectively: a peak 1 is trifolirhizin at 14.73 min, a peak 2 is naringenin at 17.31 min, a peak 3 is kaempferol at 22.85 min, a peak 4 is valine at 24.98 min, a peak 5 is palmatine at 26.89 min, a peak 6 is epiberberine at 28.03 min, a peak 7 is liquiritigenin/isoliquiritigenin at 32.76 min, a peak 8 is limonin at 35.62 min, a peak 9 is liquiritin at 37.68 min, a peak 10 is tetrandrine at 44.75 min, a peak 11 is methylophiopogonanone A at 50.83 min, a peak 12 is lotusine at 54.08 min, a peak 13 is sophoridine/matrine at 63.19 min, a peak 14 is sophoranol/oxymatrine at 69.17 min, a peak 15 is kurarinone at 87.14 min, a peak 16 is dehydropachymic acid at 96.23 min, a peak 17 is polyporenic acid C at 108.77 min, a peak 18 is quercetin at 113.61 min, and a peak 19 is sophocarpine at 118.39 min.
S5. Methodological inspection

### 1. Stability Experiment

The test article obtained in S1 is taken. Sample injection and analysis are performed according to the chromatographic condition in S2 at 0 h, 2 h, 4 h, 8 h, 12 h, and 24 h respectively. Trifolirhizin, naringenin, kaempferol, valine, palmatine, epiberberine, liquiritigenin, isoliquiritigenin, limonin, liquiritin, tetrandrine, methylophiopogonanone, lotusine, sophoridine, matrine, sophoranol, oxymatrine, kurarinone, dehydropachymic acid, polyporenic acid, quercetin, sophocarpine are used as reference peaks. A peak area and a retention time of a common peak of an HPLC fingerprint of a sample are analyzed, RSD values are calculated, and a chromatogram is recorded. See Table 12 for results. As can be seen from Table 12, a ratio of a relative retention time of each main chromatographic peak and a relative peak area of the chromatographic peak has no significant change, RSDs are respectively 0.32%-3.07% and 0.45%-3.37%. When the RSD<5.0%, it indicates that the constituents of the test article solution are stable within 24 h.

### 2. Precision Experiment

The test article obtained in S1 is taken. Measurement is performed consecutively 6 times according to the chromatographic condition in S2. Trifolirhizin, naringenin, kaempferol, valine, palmatine, epiberberine, liquiritigenin, isoliquiritigenin, limonin, liquiritin, tetrandrine, methylophiopogonanone, lotusine, sophoridine, matrine, sophoranol, oxymatrine, kurarinone, dehydropachymic acid, polyporenic acid, quercetin, and sophocarpine are used as reference peaks. A peak area and a retention time of a common peak of an HPLC fingerprint of a sample are analyzed, RSD values are calculated, and a chromatogram is recorded. See Table 12 for results. As can be seen, a ratio of a relative retention time of each main chromatographic peak and a relative peak area of the chromatographic peak has no significant change. RSDs are respectively 0.55%-3.40% and 0.27%-3.22%. When RSD<5.0%, it indicates that the precision of the instrument is good.

### 3. Repeatability Experiment

6 pieces of test articles of the Xin Su Ning capsule are taken. Sample injection and analysis are respectively performed according to the foregoing chromatographic condition. Trifolirhizin, naringenin, kaempferol, valine, palmatine, epiberberine, liquiritigenin, isoliquiritigenin, limonin, liquiritin, tetrandrine, methylophiopogonanone, lotusine, sophoridine, matrine, sophoranol, oxymatrine, kurarinone, dehydropachymic acid, polyporenic acid, quercetin, sophocarpine are used as reference peaks. A peak area and a retention time of a common peak of an HPLC fingerprint of a sample are analyzed, RSD values are calculated, and a chromatogram is recorded. See Table 12 for results. A ratio of a relative retention time of each main chromatographic peak and a relative peak area of the chromatographic peak has no significant change. RSDs are respectively 0.34%-3.78% and 0.41%-3.91%. When RSD<5.0%, it indicates that the experiment method has adequate repeatability.

TABLE 12
Results of methodological inspection of a fingerprint of a Xin Su Ning capsule

| | Stability RSD (%) | | Precision RSD (%) | | Repeatability RSD (%) | |
|---|---|---|---|---|---|---|
| Common | Relative | Relative | Relative | Relative | Relative | Relative |
| peak | retention time | peak area | retention time | peak area | retention time | peak area |
| 1 | 0.56 | 1.43 | 2.14 | 1.09 | 0.87 | 1.12 |
| 2 | 1.34 | 0.97 | 2.78 | 0.78 | 1.33 | 3.44 |
| 3 | 0.93 | 2.45 | 0.71 | 3.22 | 2.56 | 1.76 |
| 4 | 2.73 | 0.73 | 1.45 | 2.41 | 1.13 | 0.41 |
| 5 | 1.56 | 1.65 | 3.40 | 1.53 | 0.74 | 1.79 |
| 6 | 1.29 | 1.49 | 0.64 | 0.61 | 0.66 | 2.67 |
| 7 | 3.07 | 0.48 | 1.53 | 0.78 | 2.73 | 3.79 |
| 8 | 0.86 | 0.49 | 2.56 | 1.67 | 3.70 | 0.88 |
| 9 | 2.71 | 3.37 | 0.55 | 2.31 | 1.41 | 1.59 |
| 10 | 0.64 | 2.61 | 1.13 | 3.17 | 0.34 | 2.30 |
| 11 | 0.83 | 1.83 | 1.76 | 0.56 | 1.54 | 3.57 |
| 12 | 1.03 | 0.54 | 2.08 | 0.74 | 2.37 | 3.19 |
| 13 | 2.37 | 0.88 | 2.44 | 1.27 | 1.69 | 0.47 |
| 14 | 0.32 | 1.25 | 3.12 | 2.55 | 2.77 | 0.60 |
| 15 | 0.79 | 1.67 | 0.84 | 0.27 | 0.48 | 1.79 |
| 16 | 1.32 | 2.37 | 0.65 | 1.48 | 3.78 | 2.84 |
| 17 | 2.15 | 1.76 | 1.29 | 1.93 | 1.32 | 3.91 |
| 18 | 0.92 | 0.45 | 0.48 | 0.44 | 2.65 | 0.75 |
| 19 | 0.81 | 1.29 | 1.65 | 2.17 | 0.47 | 3.23 |

The foregoing experimental results show that the method for constructing a fingerprint of a Xin Su Ning capsule provided in the present invention has characteristics of good stability, high precision, and good repeatability, can comprehensively and objectively evaluate the quality of a Xin Su Ning capsule, to provide quality assurance for clinical therapeutic effectiveness.

The above embodiments are only exemplary embodiments of the present invention and are not intended to limit the present invention, and the scope of protection of the present invention is defined by the claims. Persons skilled in the art may make various modifications or equivalent replacements to the present invention within the essence and the scope of protection of the present invention, and such modifications or equivalent replacements shall also be regarded as falling within the scope of protection of the present invention.

1. A method for constructing a fingerprint of a Xin Su Ning capsule, comprising the following steps:
S1: taking contents of Xin Su Ning capsules of different batches, adding a methanol aqueous solution, and performing ultrasonic extraction to obtain test article solutions;
S2: injecting the test article solutions into a high performance liquid chromatograph, performing gradient elution, performing chromatographic analysis, and recording chromatograms from 0 to 140 min;
S3: importing the chromatograms obtained in S2 into a traditional Chinese medicine chromatographic fingerprint similarity evaluation system, selecting chromatographic peaks that exist in all the chromatograms of the Xin Su Ning capsules of different batches as common peaks, and performing data importing, multipoint correction, and data matching on the chromatograms of the test article solutions, to obtain a fingerprint; and
S4: performing mass spectral analysis on the test article solutions, and determining chemical constituents of the chromatographic peaks in the fingerprint according to results of the mass spectral analysis.

2. The method for constructing a fingerprint of a Xin Su Ning capsule according to claim 1, wherein in S1, a volume concentration of methanol in the methanol aqueous solution is 80%.

3. The method for constructing a fingerprint of a Xin Su Ning capsule according to claim 1, wherein in S1, a time of the ultrasonic extraction ranges from 20 min to 40 min.

4. The method for constructing a fingerprint of a Xin Su Ning capsule according to claim 1, wherein in S2, a detection wavelength used in the chromatographic analysis is 210 nm.

5. The method for constructing a fingerprint of a Xin Su Ning capsule according to claim 1, wherein in S2, a chromatographic column used in the high performance liquid chromatograph is a Hedera ODS-2-C18 (250 mm×4.6 mm, 10 μm) chromatographic column.

6. The method for constructing a fingerprint of a Xin Su Ning capsule according to claim 1, wherein in S2, a mobile phase used in the gradient elution is acetonitrile and a 0.1% formic acid aqueous solution.

7. The method for constructing a fingerprint of a Xin Su Ning capsule according to claim 6, wherein in S2, a procedure of the gradient elution is shown in the following table:

| Time (min) | Volume (%) of acetonitrile |
|---|---|
| 0-35 | 20-27 |
| 25-45 | 27-35 |
| 45-85 | 35-45 |
| 85-95 | 45-65 |
| 95-140 | 65-100 |

8. The method for constructing a fingerprint of a Xin Su Ning capsule according to claim 1, wherein in S2, a flow rate used in the gradient elution is 0.8 mL/min.

9. The method for constructing a fingerprint of a Xin Su Ning capsule according to claim 1, wherein in S4, it is determined that the chemical constituents of the chromatographic peaks in the fingerprint are respectively: a peak 1 is trifolirhizin, a peak 2 is naringenin, a peak 3 is kaempferol, a peak 4 is valine, a peak 5 is palmatine, a peak 6 is epiberberine, a peak 7 is liquiritigenin/isoliquiritigenin, a peak 8 is limonin, a peak 9 is liquiritin, a peak 10 is tetrandrine, a peak 11 is methylophiopogonanone A, a peak 12 is lotusine, a peak 13 is sophoridine/matrine, a peak 14 is sophoranol/oxymatrine, a peak 15 is kurarinone, a peak 16 is dehydropachymic acid, a peak 17 is polyporenic acid C, a peak 18 is quercetin, and a peak 19 is sophocarpine.

10. A fingerprint of a Xin Su Ning capsule constructed by using the method according to claim 1.
